(19) United States
(12) Patent Application Publication
(10) Pub. No.: US 2014/0343934 A1
(43) Pub. Date: Nov. 20, 2014

(54) Method, Apparatus, and Speech Synthesis System for Classifying Unvoiced and Voiced Sound

(71) Applicant: Tencent Technology (Shenzhen) Company Limited, Shenzhen (CN)

(72) Inventor: Zongyao TANG, Shenzhen (CN)

(73) Assignee: Tencent Technology (Shenzhen) Company Limited, Shenzhen (CN)

(21) Appl. No.: 14/186,933

(22) Filed: Feb. 21, 2014

Related U.S. Application Data
(63) Continuation of application No. PCT/CN2013/087821, filed on Nov. 26, 2013.

(30) Foreign Application Priority Data
May 15, 2013 (CN) 2013101798620

(51) Int. Cl. G10L 25/93

(52) U.S. Cl. CPC G10L 25/93
USPC 704/208

(57) ABSTRACT

A method, apparatus, and speech synthesis system are disclosed for classifying unvoiced and voiced sound. The method includes: setting an unvoiced and voiced sound classification question set; using speech training data and the unvoiced and voiced sound classification question set for training a sound classification model of a binary decision tree structure, where the binary decision tree structure includes non-leaf nodes and leaf nodes, the non-leaf nodes represent questions in the unvoiced and voiced sound classification question set, and the leaf nodes represent unvoiced and voiced sound classification results; and receiving speech test data, and using the trained sound classification model to decide whether the speech test data is unvoiced sound or voiced sound.

### CROSS-REFERENCE TO RELATED APPLICATIONS

This application is a continuation of International Application No. PCT/CN2013/087821, filed on Nov. 26, 2013, which claims priority to 201310179862.0, “METHOD, APPARATUS, AND SPEECH SYNTHESIS SYSTEM FOR CLASSIFYING UNVOICED AND VOICED SOUND,” filed on May 15, 2013, both of which are hereby incorporated herein by reference in their entireties.

### FIELD

The present disclosure relates generally to the field of speech processing technology and, more particularly, to a method, apparatus and speech synthesis system for classifying unvoiced and voiced sound.

### BACKGROUND

In today's information age, numerous information equipment emerge and they include fixed line telephones and mobile phones for speech transmission; servers and personal computers for information resource sharing and processing; and various television sets for visual data display. These equipment come into being to meet actual demand in specific fields. Along with the integration of electronic consumption, computer and communication, people are increasingly focusing on research of the comprehensive use of information equipment in various fields so as to fully utilize the presently available resources and equipment to provide better services to the people.

Speech synthesis is a technique whereby artificial speech is generated using mechanical or electronic method. Text-to-speech (TTS) technique is a type of speech synthesis that converts computer generated or externally inputted text information into speech output. In speech synthesis, unvoiced and voiced sound classification is usually involved. The unvoiced and voiced sound classification generally is used to decide whether sound data is unvoiced or voiced.

In a prior art speech synthesis system, the unvoiced and voiced sound classification model is based on multi-space probability distribution and is combined with a fundamental frequency parameter model for training. A voiced sound is determined based on its weight, and once the weight value is less than 0.5, the sound is decided to be an unvoiced sound and the values of the voiced sound portion of the model will no longer be used.

However, the question set designed for the training of a hidden Markov model (HMM) is not specifically intended for classifying unvoiced and voiced sound and in the prediction process, the questions in the decision tree may not at all be related to unvoiced and voiced sound but is configured to decide unvoiced and voiced sound, and this naturally results in inaccurate unvoiced and voiced sound classification. When the accuracy of unvoiced and voiced sound classification is not high enough and results in errors, devoicing of voiced sound and voicing of unvoiced sound will severely affect the synthesis results of the synthesized voice.

### SUMMARY

The present disclosure provides a method and an apparatus for classifying unvoiced and voiced sound to improve the success rate of unvoiced and voiced sound classifications. The present disclosure further provides a speech synthesis system to improve the quality of speech synthesis.

In an aspect of the disclosure, a method includes: setting an unvoiced and voiced sound classification question set; using speech training data and the unvoiced and voiced sound classification question set for training a sound classification model of a binary decision tree structure, where the binary decision tree structure includes non-leaf nodes and leaf nodes, the non-leaf nodes represent questions in the unvoiced and voiced sound classification question set, and the leaf nodes represent unvoiced and voiced sound classification results; and receiving speech test data, and using the trained sound classification model to decide whether the speech test data is unvoiced sound or voiced sound.

In a second aspect, an apparatus is disclosed for classifying unvoiced and voiced sound. The apparatus includes a hardware processor and a non-transitory computer-readable storage medium configured to store: an unvoiced and voiced sound classification question set setting unit, a model training unit, and an unvoiced and voiced sound classification unit. The unvoiced and voiced sound classification question set setting unit is configured to set an unvoiced and voiced sound classification question set. The model training unit is configured to use speech training data and the unvoiced and voiced sound classification question set for training a sound classification model of a binary decision tree structure, where the binary decision tree structure includes non-leaf nodes and leaf nodes, the non-leaf nodes represent questions in the unvoiced and voiced sound classification question set, and the leaf nodes represent unvoiced and voiced sound classification results. The unvoiced and voiced sound classification unit is configured to receive speech test data, and use the trained unvoiced and voiced sound classification model to decide whether the speech test data is unvoiced sound or voiced sound.

In a third aspect, a speech synthesis system includes an unvoiced and voiced sound classification apparatus and a speech synthesizer. The unvoiced and voiced sound classification apparatus is configured to set an unvoiced and voiced sound classification question set; use speech training data and the unvoiced and voiced sound classification question set for training a sound classification model of a binary decision tree structure, where the binary decision tree structure includes non-leaf nodes and leaf nodes, the non-leaf nodes represent questions in the unvoiced and voiced sound classification question set, and the leaf nodes represent unvoiced and voiced sound classification results; receiving speech test data, and using the trained sound classification model to decide whether the speech test data is unvoiced sound or voiced sound; and using a hidden Markov model (HMM) to predict the fundamental frequency value of the speech test data, after using the trained sound classification model to decide that the speech test data is a voiced sound. The speech synthesizer is configured to synthesize speech based on the fundamental frequency value and spectral parameter of the speech test data, where the excitation signal of the speech test data in the speech synthesis process is assumed to be an impulse response sequence once the speech test data is decided to be a voiced sound; and the excitation signal of the speech test data in the speech synthesis process is assumed to be a white noise once the speech test data is decided to be an unvoiced sound.

It can be seen from the foregoing scheme that the method provided by the present disclosure comprises: setting an unvoiced and voiced sound classification question set; using speech training data and the unvoiced and voiced sound classification question set for training a sound classification model of a binary decision tree structure, where the binary decision tree structure includes non-leaf nodes and leaf nodes, the non-leaf nodes represent questions in the unvoiced and voiced sound classification question set, and the leaf nodes represent unvoiced and voiced sound classification results; and receiving speech test data, and using the trained sound classification model to decide whether the speech test data is unvoiced sound or voiced sound. It can therefore be seen that the present disclosure uses an independent sound classification model for classifying the unvoiced and voiced phoneme status of a synthesized voice, and thereby improving the success rate of unvoiced and voiced sound classifications.

In addition, the present disclosure overcomes the disadvantage of low synthesis results caused by devoicing of voiced sound and voicing of unvoiced sound, and thereby improving the quality of speech synthesis.

### BRIEF DESCRIPTION OF THE DRAWINGS

FIG. 1 is a process flow diagram of an embodiment of the method for classifying unvoiced and voiced sound according to the present disclosure.

FIG. 2 is a schematic diagram of an embodiment of the binary decision tree structure according to the present disclosure.

FIG. 3 is a schematic diagram of an embodiment of the use of the binary decision tree structure according to the present disclosure.

FIG. 4(a) is a schematic block diagram of an embodiment of an apparatus according to an embodiment of the disclosure.

FIG. 4(b) is a schematic block diagram of an embodiment of the unvoiced and voiced sound classification apparatus according to the present disclosure.

FIG. 5 is a schematic structural diagram of an embodiment of the speech synthesis system according to the present disclosure.

### DETAILED DESCRIPTION OF THE DRAWINGS

For a better understanding of the aim, solution, and advantages of the present disclosure, various example embodiments are described in further details in connection with the accompanying drawings as follows. The various embodiments may be combined at least partially.

In a hidden Markov model (HMM) based trainable text-to-speech (TTS) system, speech signals are converted into excitation parameters and spectral parameters according to frame. The excitation parameters and spectral parameters are separately trained to be hidden Markov model (HMM) training parts. Thereafter, speech is synthesized at the speech synthesis part by a synthesizer (vocoder) based on unvoiced and voiced sound classification, voiced sound fundamental frequency and spectral parameters predicted based on a hidden Markov model (HMM).

In the synthesis stage, if a certain frame is decided to be a voiced sound, then the excitation signal is assumed to be an impulse response sequence; and if the frame is decided to be an unvoiced sound, then the excitation signal is assumed to be a white noise. If the unvoiced and voiced sound classification is incorrect, devoicing of voiced sound and voicing of unvoiced sound will occur and severely affect the final synthesis results.

However, the question set designed for the training of a hidden Markov model (HMM) is not specifically intended for classifying unvoiced and voiced sound and in the prediction process, the questions in the decision tree may not at all be related to unvoiced and voiced sound but is configured to decide unvoiced and voiced sound, and this naturally results in inaccurate unvoiced and voiced sound classification. When the accuracy of unvoiced and voiced sound classification is not high enough and results in errors, devoicing of voiced sound and voicing of unvoiced sound will severely affect the synthesis results of the synthesized voice.

The present disclosure provides a method for classifying unvoiced and voiced sound.

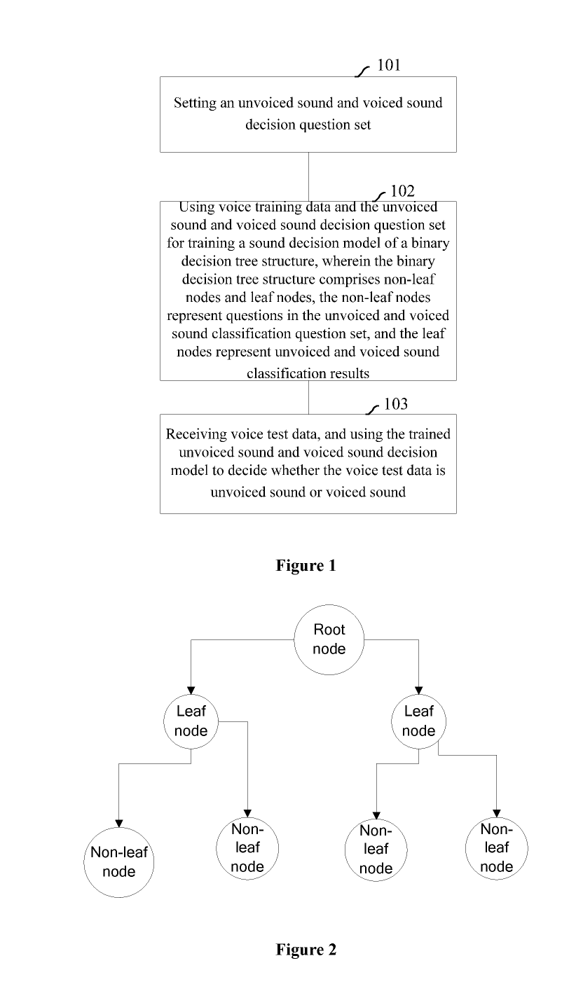

FIG. 1 is a process flow diagram of an embodiment of the method for classifying unvoiced and voiced sound according to the present disclosure.

As shown in FIG. 1, the method comprises:

Step 101: setting an unvoiced and voiced sound classification question set.

Here, a question set specifically intended for classifying unvoiced and voiced sound is first designed and referred to as an unvoiced and voiced sound classification question set. The unvoiced and voiced sound classification question set contains plenty of affirmative/negative type of questions, including but not limited to queries about the following information:

(1) Speech information about the phoneme of the speech test data: e.g. is the phoneme of the speech test data a vowel; is it a plosive sound; is it a fricative sound; is it a nasal sound; is it pronounced with stress; is it a specific phoneme; is it pronounced in the first tone; is it pronounced in the second tone; is it pronounced in the third tone; is it pronounced in the fourth tone, etc.

(2) Speech information about the phoneme preceding the phoneme of the speech test data in the sentence: e.g. is the phoneme preceding the phoneme of the speech test data in the sentence a vowel; is it a plosive sound; is it a fricative sound; is it a nasal sound; is it pronounced with stress; is it a specific phoneme; is it pronounced in the first tone; is it pronounced in the second tone; is it pronounced in the third tone; is it pronounced in the fourth tone, etc.

(3) Speech information about the phoneme following the phoneme of the speech test data in the sentence: e.g. is the phoneme following the phoneme of the speech test data in the sentence a vowel; is it a plosive sound; is it a fricative sound; is it a nasal sound; is it pronounced with stress; is it a specific phoneme; is it pronounced in the first tone; is it pronounced in the second tone; is it pronounced in the third tone; is it pronounced in the fourth tone, etc.

(4) Which status the phoneme of the speech test data is in (usually a phoneme is divided into 5 statuses), the tone of the phoneme of the speech test data, and whether the phoneme of the speech test data is pronounced with stress, etc.

The unvoiced and voiced sound classification question set contains affirmative/negative type of questions, and at least one of the following questions is set in the unvoiced and voiced sound classification question set:

is the phoneme of the speech test data a vowel; is the phoneme of the speech test data a plosive sound; is the phoneme of the speech test data a fricative sound; is the phoneme of the speech test data pronounced with stress; is the phoneme of the speech test data a nasal sound; is the phoneme of the speech test data pronounced in the first tone; is the phoneme of the speech test data pronounced in the second tone; is the phoneme of the speech test data pronounced in the third tone; is the phoneme of the speech test data pronounced in the fourth tone; is the phoneme preceding the phoneme of the speech test data in the speech sentence a vowel; is the phoneme preceding the phoneme of the speech test data in the speech sentence a plosive sound; is the phoneme preceding the phoneme of the speech test data in the speech sentence a fricative sound; is the phoneme preceding the phoneme of the speech test data in the speech sentence pronounced with stress; is the phoneme preceding the phoneme of the speech test data in the speech sentence a nasal sound; is the phoneme preceding the phoneme of the speech test data in the speech sentence a nasal sound; is the phoneme preceding the phoneme of the speech test data in the speech sentence pronounced in the first tone; is the phoneme preceding the phoneme of the speech test data in the speech sentence pronounced in the second tone; is the phoneme preceding the phoneme of the speech test data in the speech sentence pronounced in the third tone; is the phoneme preceding the phoneme of the speech test data in the speech sentence pronounced in the fourth tone; is the phoneme following the phoneme of the speech test data in the speech sentence a vowel; is the phoneme following the phoneme of the speech test data in the speech sentence a plosive sound; is the phoneme following the phoneme of the speech test data in the speech sentence a fricative sound; is the phoneme following the phoneme of the speech test data in the speech sentence pronounced with stress; is the phoneme following the phoneme of the speech test data in the speech sentence a nasal sound; is the phoneme following the phoneme of the speech test data in the speech sentence pronounced in the first tone; is the phoneme following the phoneme of the speech test data in the speech sentence pronounced in the second tone; is the phoneme following the phoneme of the speech test data in the speech sentence pronounced in the third tone; is the phoneme following the phoneme of the speech test data in the speech sentence pronounced in the fourth tone.

Where a phoneme is similar to Chinese phonetic notation or English international phonetic transcription and is a speech segment.

Step 102: using speech training data and the unvoiced and voiced sound classification question set for training an unvoiced and voiced sound classification model of a binary decision tree structure, where the non-leaf nodes of the binary decision tree structure are questions in the unvoiced and voiced sound classification question set and the leaf nodes are unvoiced and voiced sound classification results.

Here, the respective voiced sound ratios of speech training data with affirmative and negative answers in respect of each question in the unvoiced and voiced sound classification question set are separately computed, and the question with the largest voiced sound ratio difference is selected as a root node; and the speech training data under the root node is split to form non-leaf nodes and leaf nodes.

The splitting is stopped when a preset split stopping condition is met, where the split stopping condition is: the speech training data of the non-leaf nodes or the leaf nodes is less than a preset first threshold, or the voiced sound ratio differences of the non-leaf nodes or the leaf nodes are less than a preset second threshold.

In computer science, a binary tree is an ordered tree in which each node has a maximum of two subtrees. Usually the roots of a subtree are respectively called “left subtree” and “right subtree”. Binary trees are often used as binary search trees and binary heaps or binary sort trees. Each node of a binary tree has a maximum of two subtrees (there exists no node with an outdegree larger than 2), and subtrees of a binary tree are divided into a left subtree and a right subtree, and the order cannot be reversed. The i layer of a binary tree has at most 2ⁱ⁻¹ nodes; a binary tree with a depth of k has at most 2̂(k)−1 nodes; for any binary tree T, if the number of its terminal nodes (i.e. the number of leaf nodes) is n0, the number of nodes is n2 when the outdegree is 2, then n0=n2+1. In the present disclosure, the non-leaf nodes in the binary decision tree structure are questions in the unvoiced and voiced sound classification question set, and the leaf nodes are unvoiced and voiced sound classification results.

FIG. 2 is a schematic diagram of an embodiment of the binary decision tree structure according to the present disclosure.

The present disclosure adopts a binary decision tree model and uses speech test data as training data, and supplementary information includes: fundamental frequency information (where fundamental frequency information of unvoiced sound is denoted by 0, and fundamental frequency information of voiced sound is indicated by log-domain fundamental frequency), the phoneme of the speech test data, the phoneme preceding and the phoneme following the speech test data (a triphone), the status ordinal of the speech test data in the phoneme (i.e. which status in the phoneme), etc.

In the training process, the respective voiced sound frame ratios of speech training data with affirmative (yes) and negative (no) answers in respect of each question in the designed question set are separately computed, and the question with the largest voiced sound ratio difference between affirmative (yes) and negative (no) answers is selected as a question of the node; and the speech training data is then split.

A split stopping condition may be preset (e.g. training data of the node is less than a certain quantity of frames or the voiced sound ratio difference of training data continuing to split is less than a certain threshold), and the unvoiced and voiced sound classification with respect to the node is then made according to the voiced sound frame ratio in the training data of leaf node (e.g. decided to be a voiced sound if voiced sound frame ratio is above 50%, and an invoiced sound if otherwise).

If it is decided to be a voiced sound, the fundamental frequency value of that frame is predicted by means of a trained hidden Markov model (HMM). In the present disclosure, multi-space probability distribution is not necessary for fundamental frequency modeling.

Step 103: receiving speech test data, and using the trained unvoiced and voiced sound classification model to decide whether the speech test data is unvoiced sound or voiced sound.

Here, speech test data is received, and the trained unvoiced and voiced sound classification model is used to decide whether the speech test data is unvoiced sound or voiced sound.

Where the excitation signal of the speech test data in the speech synthesis process is assumed to be an impulse response sequence once the speech test data is decided to be a voiced sound, and the excitation signal of the speech test data in the speech synthesis process is assumed to be a white noise once the speech test data is decided to be an unvoiced sound. In signal processing, white noise is a random signal with a flat (constant) power spectral density.

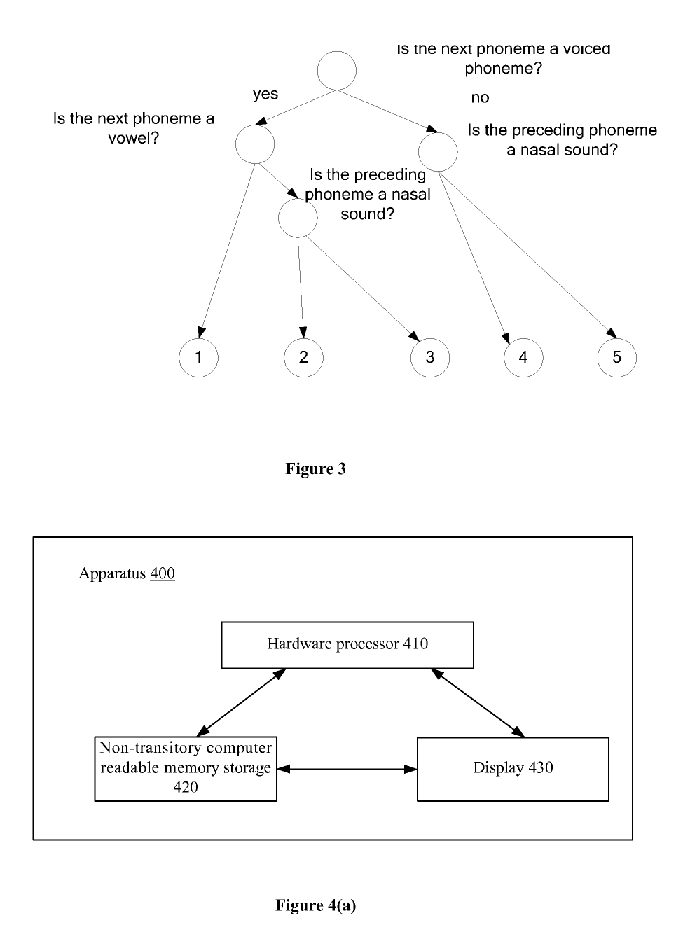

FIG. 3 is a schematic diagram of an embodiment of the use of the binary decision tree structure according to the present disclosure.

As shown in FIG. 3, the unvoiced and voiced sound classification model is a binary decision tree with each non-leaf node representing a question. Travel down the left subtree if the answer is yes, and travel down the right subtree if the answer is no. Leaf nodes represent classification results (unvoiced sound or voiced sound). If it is a voiced sound, the mean fundamental frequency value of the node is taken as a predicted fundamental frequency value.

As shown in FIG. 3, if frame data enters the process begins from the root node enquiring whether the phoneme following the phoneme of the frame is a voiced phoneme; if the answer is yes, it goes to the left subtree and enquires whether the phoneme following the phoneme of the frame is a vowel, and if the answer is no, it goes to the right subtree and enquires whether the phoneme preceding the phoneme of the frame is a nasal sound, and if the answer is yes, it goes to leaf node number 2, and if leaf node number 2 decides that it is a voiced sound, then the frame is decided to be a voiced sound.

After unvoiced and voiced sound classification, fundamental frequency prediction may be performed again. The predicted fundamental frequency value and the predicted spectral parameter are inputted into the speech synthesizer for speech synthesis. In the speech synthesis stage, if a certain frame is decided to be a voiced sound, then the excitation signal is assumed to be an impulse response sequence; and if the frame is decided to be an unvoiced sound, then the excitation signal is assumed to be a white noise.

Based on the foregoing detailed analysis, the present disclosure also provides an apparatus for classifying unvoiced and voiced sound. The apparatus may be a computer, a smart phone, or any computing device having a hardware processor and a computer-readable storage medium that is accessible to the hardware processor.

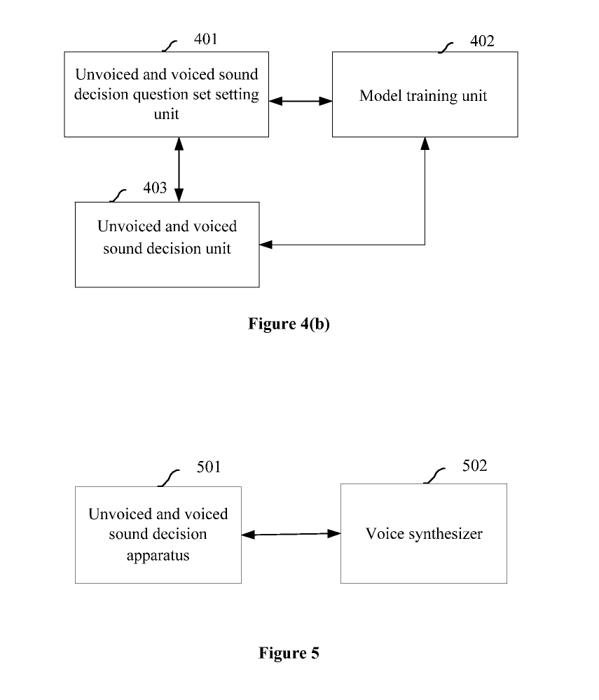

FIG. 4(a) shows a schematic block diagram of an embodiment of an apparatus 400 according to an embodiment of the disclosure. The apparatus 400 includes a processor 410, a non-transitory computer-readable memory storage 420, and display 430. The display may be a touch screen configured to detect touches and display user interfaces or other images according to the instructions from the processor 410. The processor 410 may be configured to implement methods according to the program instructions stored in the non-transitory computer-readable storage medium 420.

FIG. 4(b) is a schematic block diagram of an embodiment of the unvoiced and voiced sound classification apparatus according to the present disclosure.

As shown in FIG. 4(b), the apparatus includes: an unvoiced and voiced sound classification question set setting unit 401, a model training unit 402, and an unvoiced and voiced sound classification unit 403, all of which may be stored in a non-transitory computer-readable storage medium of the apparatus. The unvoiced and voiced sound classification question set setting unit 401 is configured to set an unvoiced and voiced sound classification question set.

The model training unit 402 is configured to use speech training data and the unvoiced and voiced sound classification question set for training an unvoiced and voiced sound classification model of a binary decision tree structure, where the non-leaf nodes of the binary decision tree structure are questions in the unvoiced and voiced sound classification question set and the leaf nodes are unvoiced and voiced sound classification results.

The unvoiced and voiced sound classification unit 403 is configured to receive speech test data, and using the trained unvoiced and voiced sound classification model to decide whether the speech test data is unvoiced sound or voiced sound.

In an embodiment: the model training unit 402 is configured to separately compute the respective voiced sound ratios of speech training data with affirmative and negative answers in respect of each question in the unvoiced and voiced sound classification question set, and selecting the question with the largest voiced sound ratio difference as a root node; and splitting the speech training data under the root node to form non-leaf nodes and leaf nodes.

In an embodiment: the model training unit 402 is configured to stop the splitting when a preset split stopping condition is met, where the split stopping condition at least comprises: the speech training data of the non-leaf nodes or the leaf nodes is less than a preset first threshold; or the voiced sound ratio differences of the non-leaf nodes or the leaf nodes are less than a preset second threshold.

In an embodiment: the model training unit 402 is further configured to acquire the fundamental frequency information of speech training data, phoneme of the speech training data and the preceding and next phonemes, and the status ordinal of the speech training data in the phoneme, and taking the fundamental frequency information of speech training data, phoneme of the speech training data and the preceding and next phonemes, and the status ordinal of the speech training data in the phoneme as supplementary information in the training process.

Based on the foregoing detailed analysis, the present disclosure also provides a speech synthesis system.

FIG. 5 is a schematic structural diagram of an embodiment of the speech synthesis system according to the present disclosure.

As shown in FIG. 5, the system comprises an unvoiced and voiced sound classification apparatus 501 and a speech synthesizer 502, where:

the unvoiced and voiced sound classification apparatus 501 is configured to set an unvoiced and voiced sound classification question set; use speech training data and the unvoiced and voiced sound classification question set for training an unvoiced and voiced sound classification model of a binary decision tree structure, where the non-leaf nodes of the binary decision tree structure are questions in the unvoiced and voiced sound classification question set and the leaf nodes are unvoiced and voiced sound classification results; receiving speech test data, and using the trained unvoiced and voiced sound classification model to decide whether the speech test data is unvoiced sound or voiced sound; and using a hidden Markov model (HMM) to predict the fundamental frequency value of the speech test data, after using the trained voiced sound classification model to decide that the speech test data is a voiced sound;

the speech synthesizer 502 is configured to synthesize speech based on the fundamental frequency value and spectral parameter of the speech test data, where the excitation signal of the speech test data in the speech synthesis process is assumed to be an impulse response sequence once the speech test data is decided to be a voiced sound; and the excitation signal of the speech test data in the speech synthesis process is assumed to be a white noise once the speech test data is decided to be an unvoiced sound.

In an embodiment: the unvoiced and voiced sound classification apparatus 501 is configured to separately compute the respective voiced sound ratios of speech training data with affirmative and negative answers in respect of each question in the unvoiced and voiced sound classification question set, and select the question with the largest voiced sound ratio difference as a root node; and splitting the speech training data under the root node to form non-leaf nodes and leaf nodes.

In an embodiment: the unvoiced and voiced sound classification apparatus 501 is configured to stop the splitting when a preset split stopping condition is met, where the split stopping condition at least comprises: the speech training data of the non-leaf nodes or the leaf nodes is less than a preset first threshold; or the voiced sound ratio differences of the non-leaf nodes or the leaf nodes are less than a preset second threshold.

The user may perform unvoiced and voiced sound classification processing on various terminals, including but not limited to multi-function mobile phones, smart mobile phones, palm computers, personal computers, panel computers, personal digital assistants (PDAs), etc.

While specific examples of terminals have been set forth above, it is apparent to those of ordinary skill in the art that these terminals are for illustrative purpose only and shall not be limiting the scope of the present disclosure. Browsers may include Microsoft® Internet Explorer, Mozilla® Firefox, Apple® Safari, Opera, Google® Chrome, GreenBrowser, etc.

While some commonly used browsers have been set forth above, it is apparent to those of ordinary skill in the art that the present disclosure shall not be limited to these browsers, but rather is applicable for applications for displaying web page servers or files in archive systems and allowing user-file interaction, and these applications may be the various common browsers and any other application programs with web page browsing function.

Actually the method, apparatus and speech synthesis system for classifying unvoiced and voiced sound provided by the present disclosure may be implemented in many ways.

For example, an application programming interface compliant with certain standards may be used to program the unvoiced and voiced sound classification method as a plug-in to be installed on personal computers, and the method may also be packaged as an application program for downloading by users. When the method is programmed as a plug-in, it may be implemented in ocx, dll, cab, etc plug-in formats. The unvoiced and voiced sound classification method provided by the present disclosure may also be implemented by means of Flash plug-in, RealPlayer plug-in, MMS plug-in, MIDI staff plug-in, ActiveX plug-in. etc.

The unvoiced and voiced sound classification method provided by the present disclosure may be stored in various storage media through instruction storage or instruction set storage. These storage media include but are not limited to floppy disks, optical disks, DVDs, hard disks, flash memory cards, U-disks, CompactFlash (CF) cards, Secure Digital (SD) cards, Multi Media Cards (MMCs), Smart Media (SM) cards, memory sticks, xD cards, etc.

In addition, the unvoiced and voiced sound classification method provided by the present disclosure may further be used on Nand flash based storage media such as U-disks, CompactFlash (CF) cards, Secure Digital (SD) cards, Standard-Capacity Secure Digital (SDSC) cards, Multi Media Cards (MMCs), Smart Media (SM) cards, memory sticks, xD cards, etc.

In summary, the method provided by the present disclosure comprises: setting an unvoiced and voiced sound classification question set; using speech training data and the unvoiced and voiced sound classification question set for training an unvoiced and voiced sound classification model of a binary decision tree structure, where the non-leaf nodes of the binary decision tree structure are questions in the unvoiced and voiced sound classification question set and the leaf nodes are unvoiced and voiced sound classification results; and receiving speech test data, and using the trained unvoiced and voiced sound classification model to decide whether the speech test data is unvoiced sound or voiced sound. It can therefore be seen that the present disclosure uses an independent unvoiced and voiced sound classification model for classifying the unvoiced/voiced phoneme status of a synthesized voice, and thereby improving the success rate of unvoiced and voiced sound classifications.

In addition, the present disclosure overcomes the disadvantage of low synthesis results caused by devoicing of voiced sound and voicing of unvoiced sound, and thereby improving the quality of speech synthesis.

Disclosed above are only example embodiments of the present disclosure and these example embodiments are not intended to be limiting the scope of the present disclosure, hence any variations, modifications or replacements made without departing from the spirit of the present disclosure shall fall within the scope of the present disclosure.

What is claimed is:

1. A method for classifying unvoiced and voiced sound, comprising:
setting an unvoiced and voiced sound classification question set;
using speech training data and the unvoiced and voiced sound classification question set for training a sound classification model of a binary decision tree structure, wherein the binary decision tree structure comprises non-leaf nodes and leaf nodes, the non-leaf nodes represent questions in the unvoiced and voiced sound classification question set, and the leaf nodes represent unvoiced and voiced sound classification results; and
receiving speech test data, and using the trained sound classification model to decide whether the speech test data is unvoiced sound or voiced sound.

2. The method of claim 1, further comprising:
setting an excitation signal of the speech test data to be an impulse response sequence when the speech test data is decided to be a voiced sound; and
setting the excitation signal of the speech test data to be a white noise when the speech test data is decided to be an unvoiced sound.

3. The method of claim 1, wherein using speech training data and the unvoiced and voiced sound classification question set for training the sound classification model of a binary decision tree structure, comprises:
separately computing respective voiced sound ratios of speech training data with affirmative and negative answers in respect of each question in the unvoiced and voiced sound classification question set, and selecting the question with the largest voiced sound ratio difference as a root node; and
splitting the speech training data under the root node to form non-leaf nodes and leaf nodes.

4. The method of claim 3, further comprising:
stopping the splitting when a preset split stopping condition is met, wherein the split stopping condition is: the speech training data of the non-leaf nodes or the leaf nodes is less than a preset first threshold.

5. The method of claim 3, further comprising:
stopping the splitting when a preset split stopping condition is met, wherein the split stopping condition is: the voiced sound ratio differences of the non-leaf nodes or the leaf nodes are less than a preset second threshold.

6. The method of claim 1, further comprising:
using a hidden Markov model (HMM) to predict a fundamental frequency value of the speech test data, after using the trained sound classification model to decide that the speech test data is a voiced sound.

7. The method of claim 1, further comprising acquiring fundamental frequency information of speech training data, phoneme of the speech training data and the preceding and next phonemes, and the status ordinal of the speech training data in the phoneme;
wherein using speech training data and the unvoiced and voiced sound classification question set for training the sound classification model of a binary decision tree structure, comprises:
taking the fundamental frequency information of speech training data, phoneme of the speech training data and the preceding and next phonemes, and the status ordinal of the speech training data in the phoneme as supplementary information in the training process.

8. The method of claim 1, wherein setting an unvoiced and voiced sound classification question set comprises: setting an affirmative/negative type of unvoiced and voiced sound classification question set, and setting at least one of the following questions about a phoneme of a speech test data in the unvoiced and voiced sound classification question set:
is the phoneme of the speech test data a vowel;
is the phoneme of the speech test data a plosive sound;
is the phoneme of the speech test data a fricative sound;
is the phoneme of the speech test data pronounced with stress;
is the phoneme of the speech test data a nasal sound;
is the phoneme of the speech test data pronounced in the first tone;
is the phoneme of the speech test data pronounced in the second tone;
is the phoneme of the speech test data pronounced in the third tone;
is the phoneme of the speech test data pronounced in the fourth tone;
is the phoneme preceding the phoneme of the speech test data in the speech sentence a vowel;
is the phoneme preceding the phoneme of the speech test data in the speech sentence a plosive sound;
is the phoneme preceding the phoneme of the speech test data in the speech sentence a fricative sound;
is the phoneme preceding the phoneme of the speech test data in the speech sentence pronounced with stress;
is the phoneme preceding the phoneme of the speech test data in the speech sentence a nasal sound;
is the phoneme preceding the phoneme of the speech test data in the speech sentence a nasal sound;
is the phoneme preceding the phoneme of the speech test data in the speech sentence pronounced in the first tone;
is the phoneme preceding the phoneme of the speech test data in the speech sentence pronounced in the second tone;
is the phoneme preceding the phoneme of the speech test data in the speech sentence pronounced in the third tone;
is the phoneme preceding the phoneme of the speech test data in the speech sentence pronounced in the fourth tone;
is the phoneme following the phoneme of the speech test data in the speech sentence a vowel;
is the phoneme following the phoneme of the speech test data in the speech sentence a plosive sound;
is the phoneme following the phoneme of the speech test data in the speech sentence a fricative sound;
is the phoneme following the phoneme of the speech test data in the speech sentence pronounced with stress;
is the phoneme following the phoneme of the speech test data in the speech sentence a nasal sound;
is the phoneme following the phoneme of the speech test data in the speech sentence pronounced in the first tone;
is the phoneme following the phoneme of the speech test data in the speech sentence pronounced in the second tone;
is the phoneme following the phoneme of the speech test data in the speech sentence pronounced in the third tone;
is the phoneme following the phoneme of the speech test data in the speech sentence pronounced in the fourth tone.

9. An apparatus for classifying unvoiced and voiced sound, comprising a hardware processor and a non-transitory computer-readable storage medium configured to store: an unvoiced and voiced sound classification question set setting unit, a model training unit, and an unvoiced and voiced sound classification unit, wherein:
the unvoiced and voiced sound classification question set setting unit is configured to set an unvoiced and voiced sound classification question set;
the model training unit is configured to use speech training data and the unvoiced and voiced sound classification question set for training a sound classification model of a binary decision tree structure, wherein the binary decision tree structure comprises non-leaf nodes and leaf nodes, the non-leaf nodes represent questions in the unvoiced and voiced sound classification question set, and the leaf nodes represent unvoiced and voiced sound classification results; and
the unvoiced and voiced sound classification unit is configured to receive speech test data, and use the trained sound classification model to decide whether the speech test data is unvoiced sound or voiced sound.

10. The apparatus of claim 9, wherein:
the model training unit is configured to separately compute respective voiced sound ratios of speech training data with affirmative and negative answers in respect of each question in the unvoiced and voiced sound classification question set, and selecting the question with the largest voiced sound ratio difference as a root node; and splitting the speech training data under the root node to form non-leaf nodes and leaf nodes.

11. The apparatus of claim 10, wherein:
the model training unit is configured to stop the splitting when a preset split stopping condition is met, wherein the split stopping condition at least comprises: the speech training data of the non-leaf nodes or the leaf nodes is less than a preset first threshold; or the voiced sound ratio differences of the non-leaf nodes or the leaf nodes are less than a preset second threshold.

12. The apparatus of claim 9, wherein:
the model training unit is further configured to acquire fundamental frequency information of speech training data, phoneme of the speech training data and the preceding and next phonemes, and the status ordinal of the speech training data in the phoneme, and take the fundamental frequency information of speech training data, phoneme of the speech training data and the preceding and next phonemes, and the status ordinal of the speech training data in the phoneme as supplementary information in the training process.

13. A speech synthesis system, comprising an unvoiced and voiced sound classification apparatus and a speech synthesizer, wherein:
the unvoiced and voiced sound classification apparatus is configured to set an unvoiced and voiced sound classification question set; using speech training data and the unvoiced and voiced sound classification question set for training a sound classification model of a binary decision tree structure, wherein the binary decision tree structure comprises non-leaf nodes and leaf nodes, the non-leaf nodes represent questions in the unvoiced and voiced sound classification question set, and the leaf nodes represent unvoiced and voiced sound classification results; receiving speech test data, and using the trained sound classification model to decide whether the speech test data is unvoiced sound or voiced sound; and using a hidden Markov model (HMM) to predict a fundamental frequency value of the speech test data, after using the trained sound classification model to decide that the speech test data is a voiced sound;
the speech synthesizer is configured to synthesize speech based on the fundamental frequency value and spectral parameter of the speech test data, wherein the excitation signal of the speech test data in the speech synthesis process is assumed to be an impulse response sequence once the speech test data is decided to be a voiced sound; and the excitation signal of the speech test data in the speech synthesis process is assumed to be a white noise once the speech test data is decided to be an unvoiced sound.

14. The speech synthesis system of claim 13, wherein:
the unvoiced and voiced sound classification apparatus is configured to separately compute the respective voiced sound ratios of speech training data with affirmative and negative answers in respect of each question in the unvoiced and voiced sound classification question set, and select the question with the largest voiced sound ratio difference as a root node; and splitting the speech training data under the root node to form non-leaf nodes and leaf nodes.

15. The speech synthesis system of claim 13, wherein:
the unvoiced and voiced sound classification apparatus is configured to stop the splitting when a preset split stopping condition is met, wherein the split stopping condition at least comprises: the speech training data of the non-leaf nodes or the leaf nodes is less than a preset first threshold; or the voiced sound ratio differences of the non-leaf nodes or the leaf nodes are less than a preset second threshold.
